(19) United States
(12) Patent Application Publication
(10) Pub. No.: US 2006/0025876 A1
(43) Pub. Date: Feb. 2, 2006

(54) Digital audio frequency optimizer

(76) Inventor: Yueh-Hua Hsu Huang, Chung-Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/900,196

(22) Filed: Jul. 28, 2004

(51) Int. Cl. G06F 17/00

(52) U.S. Cl. 700/94

(57) ABSTRACT

A kind of digital audio frequency optimizer, principally save previously frequency response curve of speaker and voice box in read-only memory (EFPROM). And CPU is control center. After reading serial signal of analog/digital signal transducer and arranging to be apposition signal through CPU, then send apposition signal to digital signal processor (DSP) to operate with frequency curve of speaker and voice box save on read-only memory. Then send operated results back to CPU to transfer to serial signal. Then transmit to digital/analog signal transducer to transfer to analog signal. After proceeding filter and amplify power by power amplifier through filter and buffer, then output speaker and voice box. Making it can output flat frequency response curve.

### BACKGROUND OF THE INVENTION

1. Field of the Invention

This invention is about a kind of digital audio frequency optimizer. In especial with refers to a kind of digital audio frequency optimizer can output flat frequency response curve through operation mode.

2. Description of the Prior Art

Conventionally used, for solving disoperation causes by speaker essence frequency response curve and additional defect of the second time frequency response curve disoperation causes by voice box, usually adds complementary circuit among circuit to proceed adjustment of speaker and voice box frequency response curve. And components of complementary circuit of conventionally used are described as follow:
1 [symbol] Conventionally used complementary circuit uses multiple passive device, e.g.: low-pass filter [symbol] high-pass filter [symbol] band-pass filter etc. multiple types filter comprise by inductance [symbol] capacitance [symbol] resistance. Arranging and combing by series or parallel method, solve frequency response disoperation by decay or increase method. Nevertheless, although method described above can improve defect of frequency response disoperation, but because it perms inductance [symbol] capacitance [symbol] resistance. Once have more frequency points on frequency curve need amend. Degree of difficulty it causes is relatively high. And number of elements it needs is relatively increased. So, while volume increases, cost will promote relatively. And this method usually only amends part can't amend overall.
2 [symbol] For improving defect makes integral circuit volume relatively increase cause by using volume of element is bigger of conventionally used complementary circuit described above, so replace filter by amplifier. It is designed to be initiative amplifier such as high-pass amplifier [symbol] low-pass amplifier [symbol] band-pass amplifier etc. by feature of amplifier in preamplifier. Applying feature of amplifier amplifying power make suitable “+ [symbol] −” method. And must perm by multiple sets of series mode or parallel mode to gain needed frequency curve. Although, volume of element needed by using circuit of multiple amplifier is smaller than applied element of filter. But the number of elements it used is more. If when frequency points needed adjustment are more will lead to need more series. So, not only cause increase of volume and cost but also making distortion relatively increase. Making it promote difficulty on design.

Furthermore, using filter or amplifier to be complementary circuit, both possess a common disadvantage, i.e. frequency response curve must be change after change speaker essence. While design and manufacture of voice box has alteration, it's frequency response curve will follow to alter too. So, while speaker and voice box have alteration, it must redesign all of circuits. Once speaker or voice box can't do any alteration will cause frequency response curve can't adjust. This is important bottleneck on design.

Hereby showing, conventional used object described above still has many defects. It is actually not a good design and need inflict improvement.

Inventor of this case examines every defects issued from complementary circuit mentioned above. So think repeatedly to improve and innovate. Studying painstakingly lonely meticulously for many years, finally researches completely this digital audio frequency optimizer successfully.

### SUMMARY OF THE INVENTION

The purpose of this invention is to provide a kind of frequency response curve of speaker and voice box can obtain at anytime. Does suitable apery adjustment previously on computer, then save data of this curve, to get digital audio frequency optimizer of the best frequency response curve.

Another purpose of this invention is to supply a kind of read-only memory saves with frequency response curve of speaker and voice box only must plug on board in manufacture process. Will complete digital audio frequency optimizer of altering design purpose at any time.

The other purpose of this invention is to provide a kind of DSP operated result transfer to serial signal through CPU. And then transmit to digital/analog signal transducer to transfer to analog signal to reduce needed load when DSP dose complicate operate. Achieve digital audio frequency optimizer with maintaining sound quality purpose progressively.

The last purpose of this invention is to provide a kind of previously setting digital/analog signal transducer which outputs maxima level. Preventing power amplifier generates cut distortion phenomenon cause by too large signal input. Making digital audio frequency optimizer dose not like traditional method which using multiple elements and complex circuit combine to be a compress circuit to improve cut distortion.

Achieving digital audio frequency optimizer of invention purposes mentioned above includes analog/digital signal transducer [symbol] CPU [symbol] digital signal processor [symbol] digital/analog signal transducer [symbol] filter/buffer [symbol] power amplifier [symbol] speaker and voice box. Therein, the read-only memory can save frequency response curve of speaker and voice box. The analog/digital signal transducer receive audio frequency signal. And transfer the audio frequency signal into digital signal then transmit to CPU. CPU will transfer signal received into apposition signal then send signal to DSP to operate with frequency curve save on read-only memory. And then send operated result back to CPU to transfer to serial signal. Then transmit to digital/analog transducer to transduce to analog signal. Then through filter and buffer proceeding filter and power amplify by power amplifier. Then output to speaker and voice box. Making it can output flat frequency response curve.

### BRIEF DESCRIPTION OF THE DRAWINGS

The drawings disclose an illustrative embodiment of the present invention which serves to exemplify the various advantages and objects hereof, and are as follows:

FIG. 1 is block diagram of digital audio frequency optimizer of this invention.

### DETAILED DESCRIPTION OF THE PREFERRED EMBODIMENT

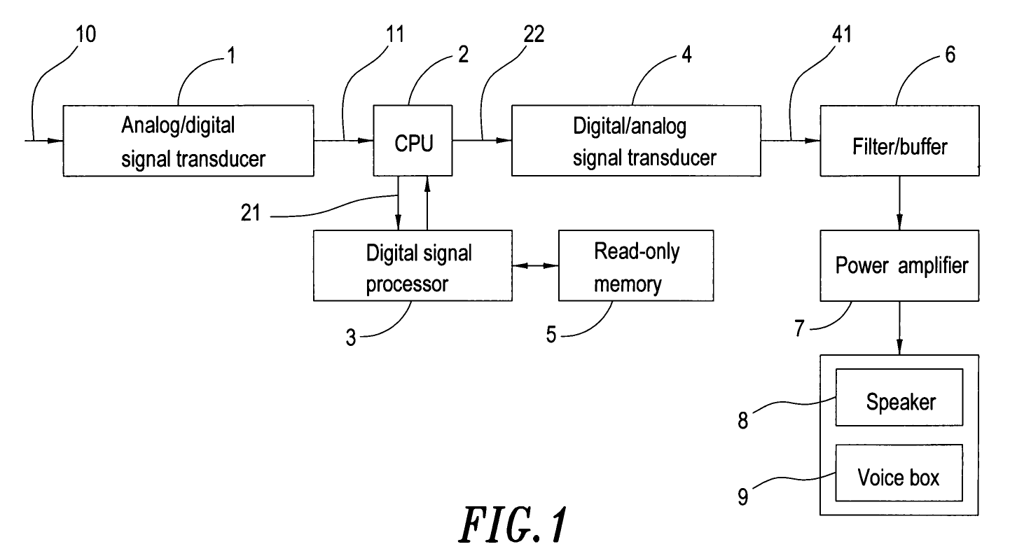

Please refer to FIG. 1, digital audio frequency optimizer supplied by this invention principally includes:

An analog/digital signal transducer 1, it receives audio frequency analog signal 10 from acoustic. And transfer the audio frequency analog signal 10 to digital serial signal 11 then transmit to CPU 2.

A CPU 2, the CPU 2 is a control center, it receives digital serial signal 11 from analog/digital signal transducer 1. And after arranging the digital serial signal 11 to apposition signal 21, then transmit the signal 21 to digital signal processor 3 (DSP) to operate. After operating, then send back operated parameter signal to CPU 2 to transfer to digital serial signal 22, and then transmit to digital/analog signal transducer 4.

A read-only memory 5 (EEPROM), the read-only memory 5 connects with digital signal processor 4. It save principally original frequency response curve parameters of speaker 8 and voice box 9.

A digital signal processor 3 (DSP), the digital signal processor 3 receives signals from CPU 2 and read-only memory 5. And proceed operation according signal received. Frequency response curve of speaker is operation parameter. E.g.: parameter value of A+parameter value of B=parameter value of C. Signal A represents frequency response curve of speaker 8 and voice box 9. Signal B equals to negative of signal A. Signal C is flat frequency response curve. So, for making speaker 8 and voice box 9 can output signal C of flat curve. Operating the digital signal processor 3, must distill signal A saves in read-only memory 5 to get negative signal B parameter of signal A. And after transmitting the negative signal B parameter back to CPU 2 to transfer back to digital serial signal 22 then transmit to digital/analog signal transducer 4. Transmitting in such way can reduce load when digital signal processor 3 do complex operation. Avoiding reducing transmitted speed, lead to relative decrease of sound quality at last.

A digital/analog signal transducer 4 receives negative signal B from CPU 2. After transferring received signal to analog signal 41, then transmit to filter/buffer to proceed filter and buffer, and then transmit to power amplifier 7 to do power amplify. At last, transmit amplified negative signal B to speaker 8 and voice box 9. Making signal A parameter plus negative signal B parameter can get signal C on frequency response curve of speaker 8 and voice box 9. The signal C will equal to “0”. Making speaker 8 and voice box 9 can output flat frequency response curve. Besides, CPU 2 will accord with operated result of digital signal processor 3 to set maximum output level of digital/analog signal transducer 4. Prevent cut distortion cause by too large signal input on power amplifier 7.

In addition, digital/analog signal transducer 4 obtains stereo audio frequency signal data from CPU 2. Can add left [symbol] right two sound tracks of low pass filter and high pass filter then divide by two through digital signal processor 3. Simultaneously add low pass filter. After operating this signal with another speaker parameter, then through another digital/analog signal transducer 4, such can obtain good curve output of another sound track (heavy bass).

Again, save original frequency response curve parameter of speaker 8 and voice box 9 on read-only memory 5 or relative similar element. Once frequency response curve of speaker 8 and voice box 9 alter, the altered frequency response curve parameter can save on read-only memory 5 or relative similar element at any time to improve defects of conventionally used complementary circuit.

Digital audio frequency optimizer supplied by this invention compares mutually with other conventionally used technique possesses follow advantages:
1. Frequency response curve of speaker and voice box obtained by this invention can do suitable apery adjustment previously on computer. Then save this curve data to get best frequency response curve.
2. In manufacture process, this invention only need plug read-only memory which save frequency response curve of speaker and voice box on board. Can complete purpose of alter design at any time.
3. This invention takes DSP operation result to transfer into serial signal through CPU. Then transmit to digital/analog signal transducer to transfer to analog signal. To reduce needed load when DSP do complex operation. Achieving progressively maintain purpose of sound quality.
4. This invention set previously output biggest level of digital/analog signal transducer. Preventing phenomenon of cut distortion when power amplifier cause by too large signal input. Making it need not like traditional method which uses multiple elements and complex circuit to combine a compress circuit to improve cut distortion.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A kind of digital audio frequency optimizer comprises:
an analog/digital signal transducer, it transferring audio frequency signal to serial signal, then transmitting to CPU;
a CPU, it being a control center, after arranging digital serial signal which it received to apposition signal, then transmitting signal to digital signal processor to do operation;
a read-only memory, it connecting with said digital signal processor, saving principally original frequency response curve parameter of speaker and voice box;
a digital signal processor, said digital signal processor receiving signals from said CPU and said read-only memory, and proceeding operation according signals received, and transmitting operated results back to said CPU to transfer to digital serial signal, then transmitting said digital serial signal to digital/analog signal transducer;
a digital/analog signal transducer, it receiving operated completely signal from said CPU, and after transferring signal received to analog signal then transmitting to filter/buffer to proceed filter and buffer, then transmitting to power amplifier to amplify power, at last, transmitting amplified signal to said speaker and said voice box, making said speaker and said voice box outputting flat frequency response curve.

2. Digital audio frequency optimizer as recited in claim 1, therein signal parameter which is operated completely by said digital signal processor being negative number of original frequency response curve parameter of said speaker and said voice box, after said speaker and said voice box receiving signal can output flat frequency response curve.

3. Digital audio frequency optimizer as recited in claim 1, therein said CPU setting output maximum level of said digital/analog signal transducer according operated results of said digital signal processor, preventing cut distortion cause by too large signal input in power amplifier.
